(19) United States
(12) Patent Application Publication
(10) Pub. No.: US 2002/0116488 A1
(43) Pub. Date: Aug. 22, 2002

(54) System and method for delivery and usage based billing for data services in telecommunication networks

(76) Inventors: Harihara Rama Subramanian, Plano, TX (US); Richard Dewitt Cox, Garland, TX (US)

Correspondence Address: THOMPSON & KNIGHT L.L.P., PATENT PROSECUTION DEPARTMENT, 801 CHERRY ST., SUITE 1600, FORT WORTH, TX, 76102, US

(21) Appl. No.: 09/780,288

(22) Filed: Feb. 9, 2001

(51) Int. Cl. G06F 15/173

(52) U.S. Cl. 709/224; 709/229

(57) ABSTRACT

A system and method for delivering and charging for data services over a netword system. A hardware device called “network access controller” (NAC) can be configured by a management system with information regarding data services available on a per-user, per-customer, or per-service basis. The access controller is able to read all data packets coming into the network and figure out whether they indicate the start of any premium service session like video on demand or whether they are from a premium user who needs special treatment. The access controller is able to process incoming data packets without leading to any degradation in performance or throughput. Once it detects the start of a specific type of data service session, then the access controller signals to the management system that this data service flow has started and supplies additional information extracted from the incoming data packet. Using this information and additional information on the capacity of the transport network and server resources, the number of service sessions already active and availability of credit, such as billing authorization information from a billing system, the management system can determine whether to allow the start of this service or not. The management system communicates this decision to the access controller and alters the Access Control Lists (ACLs) in traffic shapers appropriately. If the data service request is admitted into the network, then additional bandwidth is opened in The traffic shapers so that the end user receives the appropriate quality level for the service. If the service request is denied access, then the end user will not be able to gain access to the premium service.

### TECHNICAL FIELD

The present application relates to telecommunications, and more specifically to automated ordering, delivery and usage based billing for various data services in telecommunication networks.

### DESCRIPTION OF THE RELATED ART

In addition to traditional telephony services, numerous modes of data communications now exist. For instance, the internet provides a real-time, paper-free, cost-effective mode of communications and resource sharing through which sellers of goods and services can reach millions of potential customers. Electronic mail and remote access to computer servers are also widely used tools enabling data communications between customers. Additionally, on-line teleconferencing, interactive television, video web sites, and a myriad of other communications based services are and will be made available to users.

The backbone of the internet is a group of transport networks forming an international grid of high-speed, high-capacity data communication lines interconnecting a number of massive computers that serve as large-scale processing points or nodes. These transport networks are interconnected with each other through a plurality of interconnection points known as access network points. The backbone nodes are collectively responsible for capturing and sorting incoming information, routing information to its intended destination, and forwarding data between backbone nodes in these transport networks.

Transport networks are optical based, circuit switched or packet switched networks that allow for the transport of information, such as data, voice and video, over long distances. Connection to transport networks is achieved by establishing a physical communication channel between customer premises equipment and an access network point. The communication channel can connect customer premises equipment at one geographic location with either another customer premises equipment at a different geographic location (switched services and private line services) or to the backbone of the internet (internet access services) or to Application Service Providers (ASPs) (video on demand, collaborative applications like CAD/CAM, network storage services, FTP services, etc.). Communication channels can be narrowband (access speeds lower than 64 Kbits/sec) or broadband (access speeds above 600 Kbits/sec) depending the network technology used to connect the customer premises equipment with the network access point.

Presently, there are several types of broadband communication channels like xDSL, which includes several different types of Digital Subscriber Lines, Ethernet access, Cable access and Fixed Wireless access. Through these communication channels, end users, which include both enterprises and residential customers, are able to get only Internet-based data services. It is not possible to differentiate the quality or type of data services delivered over the Internet, and so Telecom Service Providers can't price different data services like email, web access, FTP, video on demand, network storage services and collaborative applications like CAD/CAM at different levels according to market demand and the costs of providing each service and appropriate Quality of Service (QoS) guarantees for those services.

At present, a number of problems exist in communication access networks and transport networks for providing broadband services:

There is no automated mechanism for recognizing the start of premium services. (for example, a end user wants to download a specific video from a video server in the network as a premium service on-demand as the end user has agreed to pay a higher fee for this download).

There is no automated mechanism for recognizing QoS requests from applications controlled by the end user (e.g. RSVP messages) so that the service provider can intercept and process these messages and make admission control decisions based on a number of factors like availability of capacity, billing authorization, etc.

It is not possible to control the number of such premium services that are admitted into the network to protect the QoS for each of these sessions. IP networks have the inherent problem of accommodating as many packets as possible until the network eventually slows down and QoS is affected for all users and services.

It would therefore be desirable to provide a system and method which allows data services to be identified, managed, and priced according to the type of data service provided.

### SUMMARY OF THE INVENTION

It is therefore one object of the present invention to provide an improved telecommunications network.

It is another object of the present invention to provide improved automated ordering, delivery and usage based billing for various data services in telecommunication networks.

It is yet another object of the invention to overcome the disadvantages and limitations of the prior art.

The foregoing objects are achieved as is now described. The preferred embodiment provides a system and method which enables telecom service providers to provide specific types of data services to client systems, and allows usage based charging and allocation of Quality of Service (QoS) resources on demand for these service sessions. Such QoS resources include but are not limited to bandwidth, delay, jitter and application server capacity that affect the quality of the communication channel in a packet switched network. Through this technology, wireline or wireless carriers, enterprises, network operators or other service providers are enabled to provide usage based premium broadband services, i.e., video or other rich media based services that are ordered and consumed by end users on-demand.

According to the preferred embodiment, a hardware device called “network access controller” (NAC) can be configured by a management system with information regarding data services available on a per-user, per-customer, or per-service basis. The access controller is able to read all data packets coming into the network and figure out whether they indicate the start of any premium service session like video on demand or whether they are from a premium user who needs special treatment. The access controller is able to process incoming data packets without leading to any degradation in performance or throughput. Once it detects the start of a specific type of data service session, then the access controller signals to the management system that this data service flow has started and supplies additional information extracted from the incoming data packet. Using this information and additional information on the capacity of the transport network and server resources, the number of service sessions already active and availability of credit, such as billing authorization information from a billing system, the management system can determine whether to allow the start of this service or not. The management system communicates this decision to the access controller and alters the Access Control Lists (ACLs) in traffic shapers appropriately. If the data service request is admitted into the network, then additional bandwidth is opened in the traffic shapers so that the end user receives the appropriate quality level for the service. If the service request is denied access, then the end user will not be able to gain access to the premium service.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of illustrative sample embodiments when read in conjunction with the accompanying drawings, wherein:

FIG. 1 depicts a block diagram of a premium service access control, bandwidth allocation and capacity management system in accordance with a preferred embodiment of the present invention;

FIG. 2 depicts a message flow diagram of a system and method in accordance with a preferred embodiment of the present invention;

FIG. 3 depicts a configuration message flow diagram of a system and method in accordance with a preferred embodiment of the present invention;

FIG. 4 depicts an intercept message flow diagram of a system and method in accordance with a preferred embodiment of the present invention;

FIG. 5 depicts an alert/discard message flow diagram of a system and method in accordance with a preferred embodiment of the present invention;

FIG. 6 depicts an RSVP message flow diagram of a system and method in accordance with a preferred embodiment of the present invention;

FIG. 7 depicts a message flow diagram of a system and method in accordance with a preferred embodiment of the present invention;

FIG. 8 depicts a collect statistics message flow diagram of a system and method in accordance with a preferred embodiment of the present invention; and

FIG. 9 depicts a flowchart of a process in accordance with a preferred embodiment of the present invention.

### DETAILED DESCRIPTION OF THE PREFERRED EMBODIMENTS

The numerous innovative teachings of the present application will be described with particular reference to the presently preferred embodiment (by way of example, and not of limitation).

Throughout this application, the term “premium service” will be used; this term is used to generically indicate a data service for which specific pricing would be advantageous. The pricing fi)r premium services can be ala carte, per minute, according to bandwidth required, or otherwise, and the term “premium” is not meant to limit the application to more expensive or more complex data services; rather this term is used to indicate that the data service is subject to service-specific pricing. Similarly, if all the data services available to a system are specifically priced, then all these services would be considered “premium” services within the context of this application.

A traffic shaper, as used herein, is a device which limits or directs traffic according to user definitions or set rules. The traffic shaper is used to allow or disallow specific data services. “IP” refers to Internet Protocol data communications, and MPLS refers to Multi-Protocol Label Switching data communications. IP and MPLS are two of the many protocols to which the disclosed embodiments apply.

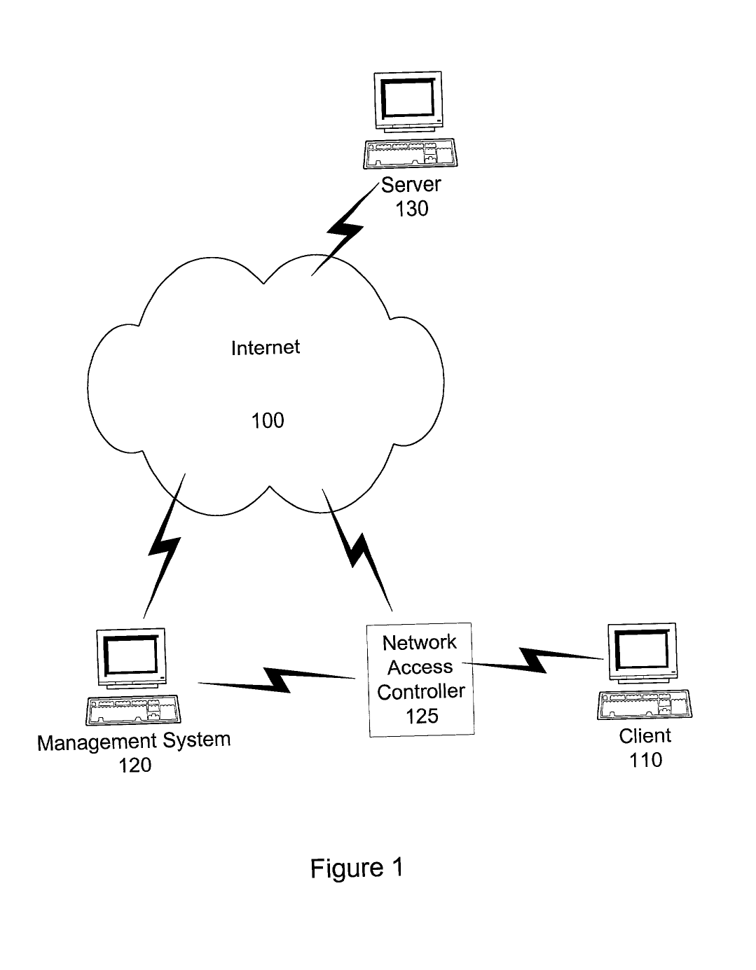

FIG. 1 depicts a block diagram of a premium service access control, bandwidth allocation and capacity management system in accordance with a preferred embodiment of the present invention. In this figure, a network system such as the Internet 100 is shown. Connected to this network system is server system 130. Server system 130 is, in this embodiment, a conventional server system connected somewhere to the internet, from which data services are requested by a client 110. Also connected to the Internet 100 are management system 120 and network access controller 125. Client system 410 is shown connected to network access controller 125. The client system, server system, management system, and network access controller can each be any of many type of data processing systems, which perform the functions described.

It should be noted that in this diagram, management system 120 and network access controller 125 are shown as discrete systems with a direct connection between them, other embodiments include combining the functions of the management system 120 and network access controller 125 into an integrated system, and eliminating the direction connection between the management system 120 and the network access controller 125 so that they communicate over the network 100. It should be further noted that while the network 100 is shown in this example as being the Internet, it can be any virtually any known type of local-area or wide-area network.

Premium Service Subscription

With reference to FIG. 1, the end user, on client system 110, comes to the service provider's service portal to subscribe to premium services. The service provider, connected to internet 100, will configure the management system 120 according to the user's subscription. This subscription information can include the type and quality level of services the end user wants and any maximum dollar limits that are allowed for the use of such services. The management system 120, which may be integrated with the service portal, can work with the billing system to authorize and confirm such subscriptions for premium services. Once the service subscription has been successful, the management system 120 can configure the access controller 125 with appropriate policy information to look for service activation requests from this specific client system 110.

Premium Service Activation

To activate the premium service, the end user can go to the service portal and order the specific service required. For example, this would mean specifying the type of video desired, when the video service is to be scheduled, etc.

Alternatively, the end user can just start using the premium service by starting the appropriate application in their desktop PC or set-top box, represented by client system 110. Since the access controller 125 has already been programmed about the premium service type and the end user information, it detects the start of a premium service transaction and informs the management system 120 of the transaction initiation, as described more fully below.

Authorization & Admission Control

The management system 120 communicates with the billing system (not shown, but which may be integrated with the management system 120) to verify whether the end user is a valid subscriber of the service and credit availability for the end user. Then the management system 120 checks the availability of network and server resources for providing this service. Once authorized, then the management system 120 allocates premium service treatment to the transaction. The management system configures the network access controller 125, including traffic shapers and other equipment in the network, to provide the premium service. The end user does not need to change any software or hardware in the LAN to receive the premium services.

Detailed Example

Consider the network configuration in FIG. 1. The enterprise user or the residential user receives services from an ASP, represented by server system 130. The end user, on client system 110, has a standard service path configured through the management system 120. The standard service, in this embodiment, is configured for 2 MB of constant service, although, of course, this figure can vary according to system needs. All interactions between the end user and the ASP are carried out over the standard service path, which includes the network access controller 125. There are some transactions between the end user and the ASP that require higher transmission rates or QoS guarantees. The end user or the ASP, depending on commercial relationship between the two companies, specifies to the management system 120 the signature of the transaction and the QoS resources needed for the transaction. The transaction signature is specified as a combination of source and destination IP addresses, port numbers and application protocol information.

The management system 120 configures the access controller system 125 to monitor all packets for the specified signature. It also configures the access controller 125 with an action instruction. The action instruction directs the access controller 125 on how to respond when a packet matches the signature. The action in this example is to alert management system 120 of the transaction and to forward the packet to the destination. When the management system 120 receives the alert it changes the configuration of the traffic shaper to increase the QoS resources to the level contracted. The access controller system 125 also can detect the end of the transaction and alert the management system 120. The management system 120 then restores the traffic shaper of network access controller 125 to police at the previous standard bandwidth.

The access controller system 125 can be configured to perform in MPLS or IP transport networks, and to many other networks, within the abilities of one of skill in the art. In MPLS deployments, the access controller 125 looks beyond the shim header to analyze the encapsulated IP packet.

One feature of the access controller system 125 is the ability to recognize the beginning and end of an IP transaction. The transaction may be TCP or UDP. The signatures for the start and end of the transactions are specified as source and destination IP addresses, source and destination port and protocol (TCP or UDP).

The access controller system 125 analyses each packet for a match for any of the premium service or transaction signatures it knows about. When a packet matches one of these signatures, the access controller 125 system performs a variety of actions. The actions are:

Alert: Inform the management system that a packet was detected matching a signature. The signature ID and specific IP header information that matched the signature is forwarded as well. The matched packet is forwarded to the destination.

Intercept: The matching packet is encapsulated in a the management system management message and forwarded to the management system. The packet is not forwarded.

Alert/Discard: Same as alert and the matching packet is discarded.

Treatment of RSVP Messages

Requests for specific data services (reservation requests or RSVP messages) from a client are handled as follows: The access controller system can be configured to recognize RSVP reservation requests from a specific source, or from any source. The action for the packet match is provisioned as Intercept. The RSVP message is sent to the management system and not forwarded. The management system capacity management analyses the resource request in the reservation message. The management system capacity management system determines if the request can be granted or not. If yes, it allocates resources based on bandwidth availability, ASP server spare capacity availability or contracted service levels. The management system then returns the RSVP altered message to the access controller system. The access controller system then sends the altered RSVP message to the original destination with the original senders IP address. The access controller monitors the packet stream for the corresponding PATH messages and informs the management system of the final negotiated reservation.

Since RSVP is a stateless protocol, the access controller monitors the packet stream for RSVP messages. When no message has been received for the prescribed time the session is terminated. The management system in informed of the session termination and resources are allocated to the transaction are recouped.

During operation, the NAC 125 typically collect and store statistical information about the data being passed, including the types of services used, the bandwidth consumed for each service, the addresses of different servers accessed, etc. The NAC 125 can be configured to collect and store virtually any statistic on the data, and will send these statistics to the management system 120 when configured to do so.

Collection of Service Statistics

Another important capability of the access controller is to monitor specific service flow. The access controller system can be configured to collect throughput statistics for these flows. The access controller system accumulates QoS statistics by flow. The management system requests the statistic information and it is forwarded to the requestor. The time that the sample collection started is also forwarded. After sending the statistics all accumulators are zeroed and a new collection is started.

Use of Statistics for Admission Control

The management system uses the statistics from all the access controller system to update its capacity model of the network. This feedback from the network provide valuable information to the management system to maintain and accurate model of the network. This information is used to determine if admission of a premium service request.

Exemplary Message Flows

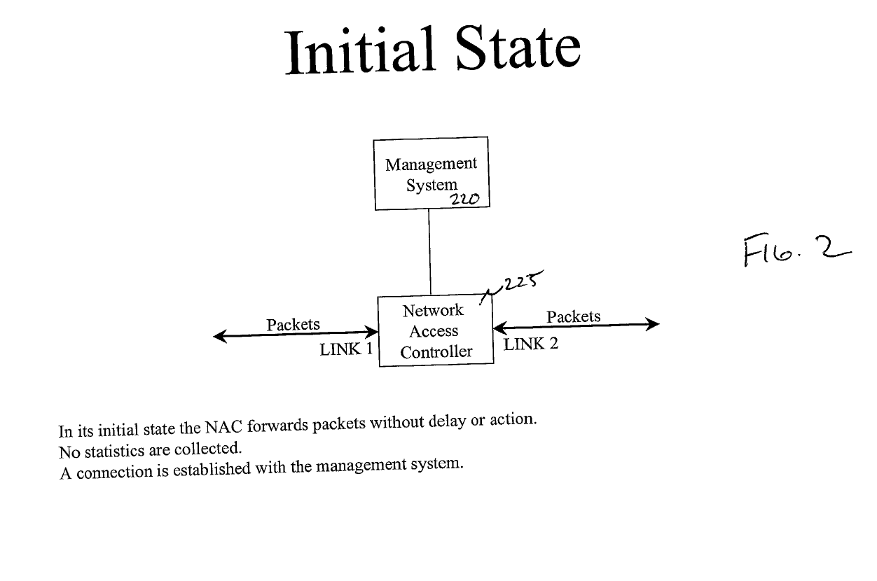

FIGS. 2-8 illustrate exemplary message flows of some of the processes and functions described above. In these figures, the management system depicted generally corresponds to management system 120 of FIG. 1, and the network access controller generally corresponds to network access controller 125 of FIG. 1. Further, in these figures, LINK1 generally corresponds to a connection, whether direct or over a network system, between a client system and the network access controller, and LINK2 generally corresponds to a connection, whether direct or over a network system, between the network access controller and a server system.

Of course, those of skill in the art will recognize that depending on data flow, and server can act as a client, and a client can act as a server. In these figures, then, LINK1 is intended to indicate the link to the system for which network data traffic is being regulated. Further, while the message flow diagrams below specifically refer to IP-protocol communications, those of skill in the art will recognize that the principles described are applicable to any data communications protocol.

FIG. 2 depicts a message flow diagram of a system and method in accordance with a preferred embodiment of the present invention. In this figure, the initial state of the system is shown. The network access controller 225 is linked to the management system 220, but no data or instructions are being passed. Packets received by network access controller 225 are passed forwarded between LINK1 and LINK2 with no delay or action.

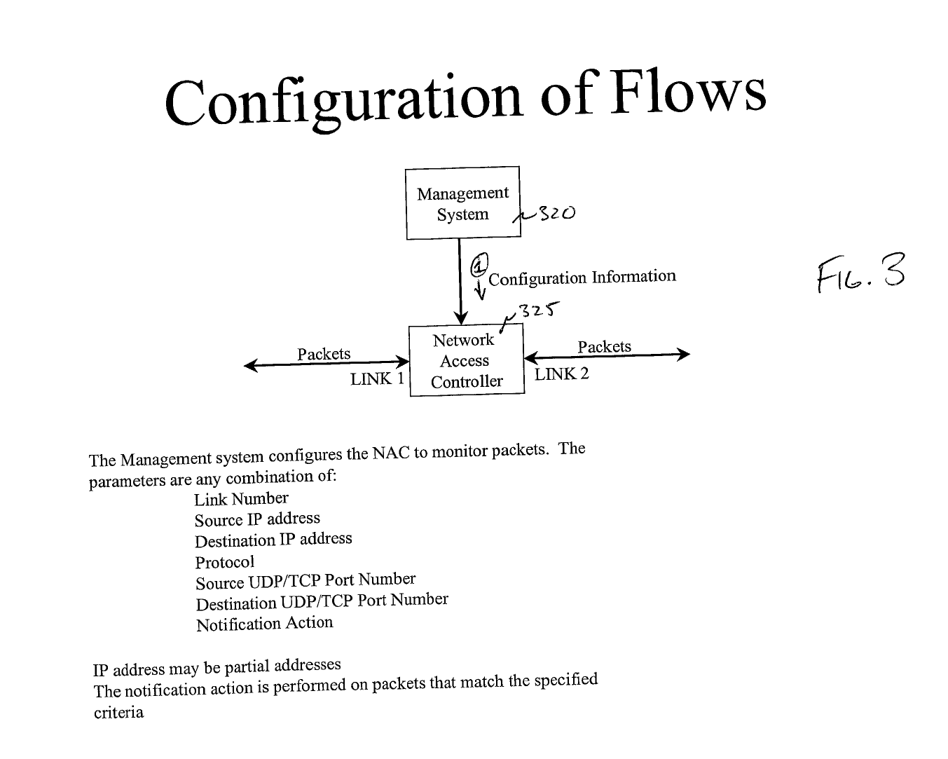

FIG. 3 depicts a configuration message flow diagram of a system and method in accordance with a preferred embodiment of the present invention. In this figure, the management system 320 configures the NAC 325 to monitor packets flowing between LINK1 and LINK2 by passing the NAC 325 configuration information including multiple configuration parameters (step 1). The parameters are any combination of:

Link Number

Source IP address

Destination IP address

Protocol

Source UDP/TCP Port Number

Destination UDP/TCP Port Number

Notification Action

The IP addresses may be partial addresses. The notification action is performed on packets that match the specified criteria. It should be noted that the parameters that can be configured are not limited to those listed above.

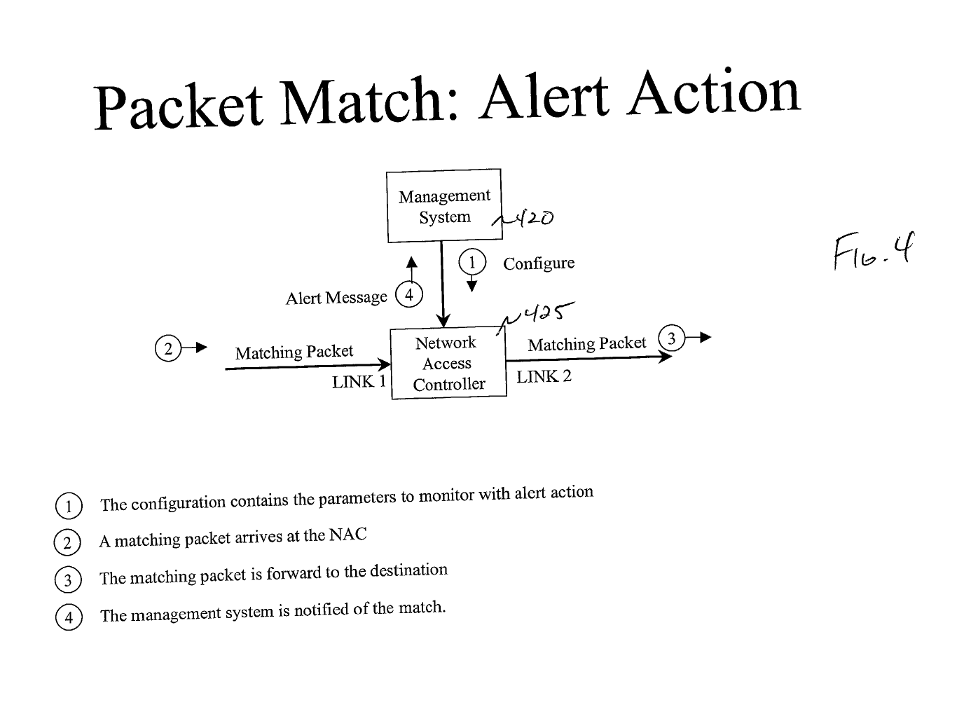

FIG. 4 depicts an alert message flow diagram of a system and method in accordance with a preferred embodiment of the present invention. The management system 420 sends configuration information to the NAC 425 (step 1). The configuration contains the parameters to monitor with alert action. A matching packet arrives at the NAC 425 (step 2). The matching packet is forwarded to the destination (step 3). The management system 420 is notified of the match (step 4).

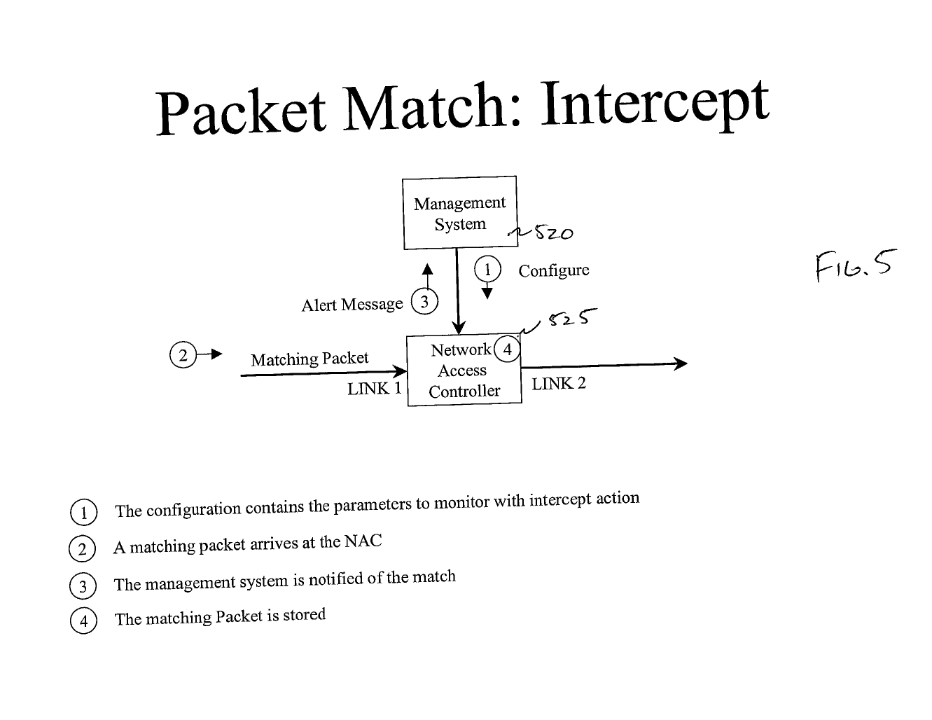

FIG. 5 depicts an intercept message flow diagram of a system and method in accordance with a preferred embodiment of the present invention. The management system 520 sends configuration information to the NAC 525 (step 1). The configuration contains the parameters to monitor with intercept action. A matching packet arrives at the NAC 625 (step 2). The management system 520 is alerted of the match (step 3). The matching packet is stored in the NAC 525, and is not forwarded (step 4).

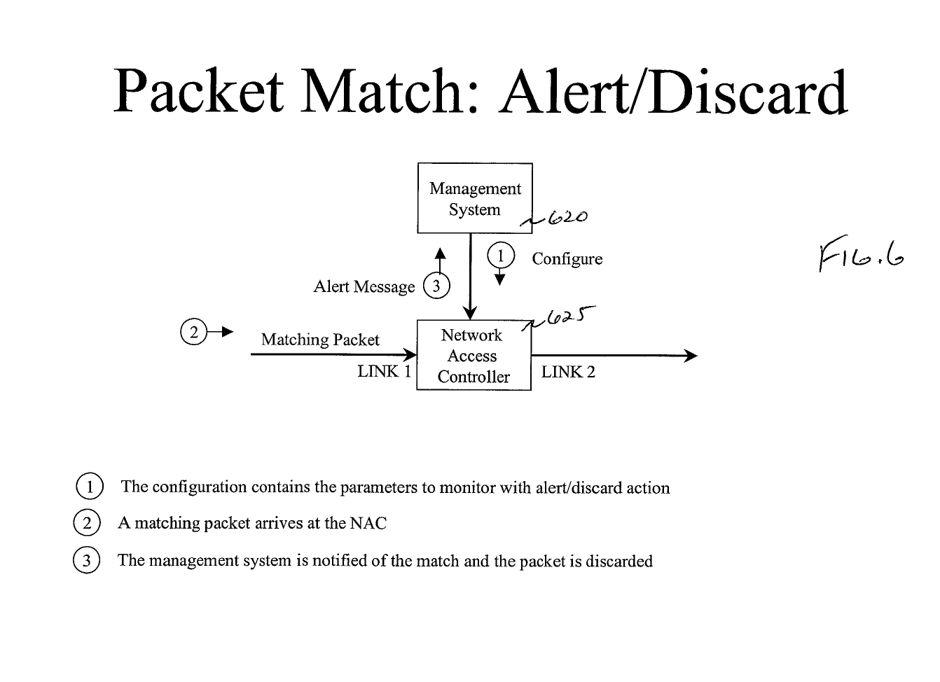

FIG. 6 depicts an alert/discard message flow diagram of a system and method in accordance with a preferred embodiment of the present invention. The management system 620 sends configuration information to the NAC 625 (step 1). The configuration contains the parameters to monitor with alert/discard action. A matching packet arrives at the NAC 625 (step 2). The management system 620 is alerted of the match (step 3). The matching packet is then discarded by the NAC 625 (step 4).

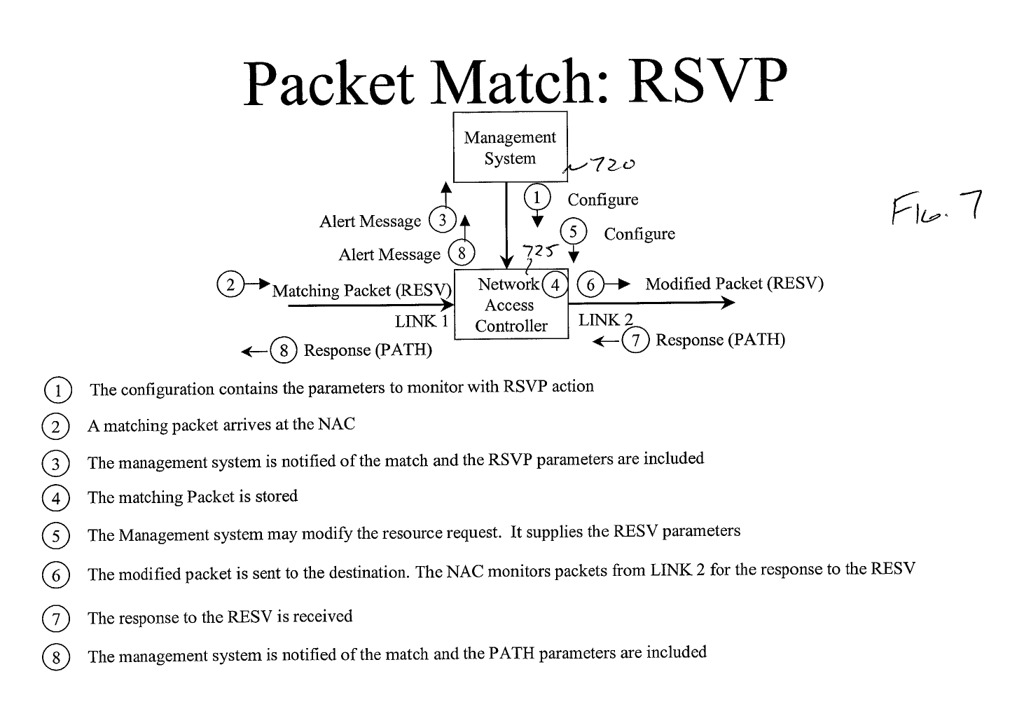

FIG. 7 depicts an RSVP message flow diagram of a system and method in accordance with a preferred embodiment of the present invention. The management system 720 sends configuration information to the NAC 725 (step 1). The configuration contains the parameters to monitor with RSVP action. A matching packet with as reservation (RESV) request arrives at the NAC 725 (step 2). The management system 720 is alerted of the match (step 3). The matching packet is stored in the NAC 725 (step 4). The management system 720 can optionally modify the resource request, then sends the RESV parameters to the NAC 725 (step 5).

The modified packet is then sent to the destination by the NAC 725, and the NAC monitors packets from LINK2 for the response to the RESV request (step 6). When a response to the RESV is received by the NAC 725 (step 7), the management system 720 is notified of the match and the PATH parameters are included (step 8).

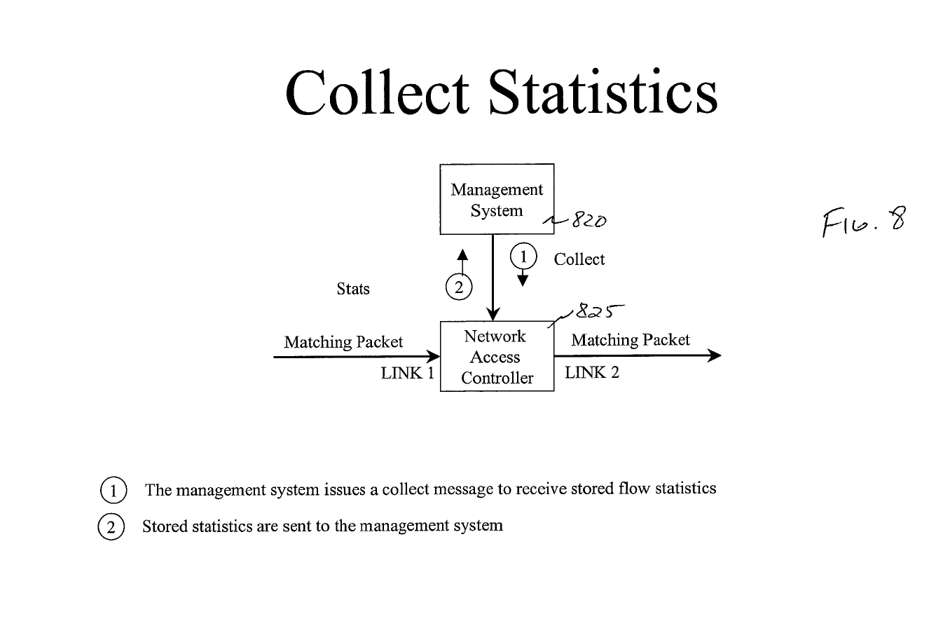

FIG. 8 depicts a collect statistics message flow diagram of a system and method in accordance with a preferred embodiment of the present invention. The management system 820 sends configuration information to the NAC 825 (step 1). The configuration contains the parameters to collect stored statistical information from the NAC 825. The NAC 825 then sends its stored statistics to the management system 820 (step 2).

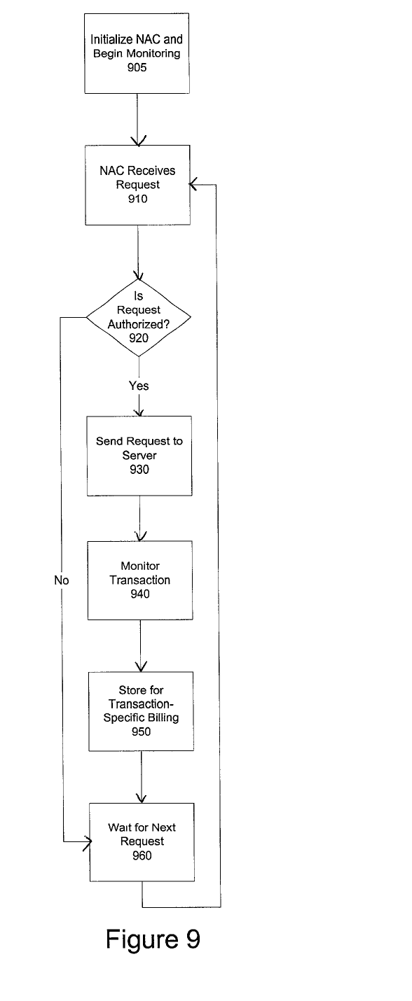

FIG. 9 depicts a flowchart of a process in accordance with a preferred embodiment of the present invention. According to this process, a network access controller is initialized by a management system and begins monitoring data flow (step 905). While monitoring, the network access controller receives a request, from a client system, for a data service to be provided from a server system (step 910). Next, the network access controller determines if the request is authorized (step 920). A table of authorizations can be already stored in the network access controller, or it the network access controller can communicate with the management system to determine authorization.

If the request is authorized, the network access controller then passes the request to the server system (step 930). If the request is not authorized, the network access controller will refuse the request and await the next request (step 960). At this point, the network access controller can store the request or discard the request, and can optionally return an error to the client.

After the network access controller has passed the request to the server system, the network access server will monitor the data passing between the client and server and can collect statistics of the transactions (step 940). The user of the client system can then be billed according to the specific authorized request and according to the statistics related to the transaction (step 950). The network access controller will then wait for the next request (step 960).

MPLS QoS Monitoring

When network access controller devices are deployed at all entry points to a MPLS network, they can send test traffic messages between each other to measure the quality of various MPLS paths. This information can be used by the policy manager for dynamic capacity management. The innovative idea here is that network access controller has new algorithms/techniques to force copies of the test traffic through various alternative MPLS paths that may exist between any two network access controller devices. This is unique because MPLS switch/routers will always use the most preferred path (based on constraints) for sending traffic between a source & a destination. The network access controller will have the ability to send copies of test traffic through all alternative paths in the MPLS network so that conclusions on “preferred” paths can be made.

MPLS Load Balancing of Service Sessions

Because of the ability to recognize start of premium service sessions and the ability to send traffic over multiple paths to the same destination, the network access controller can perform load balancing of service sessions across multiple MPLS paths. This is an innovative feature because it can ensure every service session (which consists of several packets) receives more predictable QoS as opposed to load balancing for individual packets that can disrupt QoS for service sessions.

Modifications and Variations

While the invention has been particularly shown and described with reference to a preferred embodiment, it will be understood by those skilled in the art that various changes in form and detail may be made therein without departing from the spirit and scope of the invention.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

It is important to note that while the present invention has been described in the context of a fully functional data processing system and/or network, those skilled in the art will appreciate that the mechanism of the present invention is capable of being distributed in the form of a computer usable medium of instructions in a variety of forms, and that the present invention applies equally regardless of the particular type of signal bearing medium used to actually carry out the distribution. Examples of computer usable mediums include: nonvolatile, hard-coded type mediums such as read only memories (ROMs) or erasable, electrically programmable read only memories (EEPROMs), recordable type mediums such as floppy disks, hard disk drives and CD-ROMs, and transmission type mediums such as digital and analog communication links.

What is claimed is:

1. A method, comprising the steps of:
monitoring, by a network access controller, data being transmitted from and received by a client system;
receiving, in the network access controller, a request from the client system for a data service to be provided by a server system, the request being directed to the server system;
determining if the client system is authorized for the data service;
if the client system is authorized for the data service, then sending the request to the server system.

2. The method of claim 1, wherein the network access controller monitors individual packets passing between the client and the server.

3. The method of claim 1, wherein the network access controller identifies the request by analyzing each packet transmitted from the client system.

4. The method of claim 1, wherein the network access controller determines if the client system is pre-authorized for the data service.

5. The method of claim 1, wherein the network access controller determines if the client system is authorized by for a data service by requesting authorization from a management system.

6. The method of claim 1, wherein the client system is authorized for a data service after a credit determination.

7. The method of claim 1, wherein the user of the client is billed according to the specific data services authorized for the client system.

8. The method of claim 1, wherein the network access controller discards any request from the client system which is not authorized.

9. The method of claim 1, further comprising the step of storing, in the network access controller, statistical data relating to the data services delivered to the client system.

10. A network access controller, having a least a processor and a memory, comprising:
means for monitoring data being transmitted from and received by a client system;
means for receiving a request from the client system for a data service to be provided by a server system, the request being directed to the server system;
means for determining if the client system is authorized for the data service;
means for sending the request to the server system, if the client system is authorized for the data service.

11. The network access controller of claim 10, wherein the network access controller monitors individual packets passing between the client and the server.

12. The network access controller of claim 10, wherein the network access controller identifies the request by analyzing each packet transmitted from the client system.

13. The network access controller of claim 10, wherein the network access controller determines if the client system is pre-authorized for the data service.

14. The network access controller of claim 10, wherein the network access controller determines if the client system is authorized by for a data service by requesting authorization from a management system.

15. The network access controller of claim 10, wherein the client system is authorized for a data service after a credit determination.

16. The network access controller of claim 10, wherein the user of the client is billed according to the specific data services authorized for the client system.

17. The network access controller of claim 10, wherein the network access controller discards any request from the client system which is not authorized.

18. The network access controller of claim 10, further comprising means for storing, in the network access controller, statistical data relating to the data services delivered to the client system.
